(19) United States
(12) Patent Application Publication
(10) Pub. No.: US 2008/0241645 A1
(43) Pub. Date: Oct. 2, 2008

(54) Lithium ion secondary batteries

(76) Inventors: Leslie J. Pinnell, Framingham, MA (US); Kirakodu S. Nanjundaswamy, Sharon, MA (US); George M. Cintra, Holliston, MA (US); Alexander Kaplan, Providence, RI (US)

Correspondence Address: FISH & RICHARDSON P.C., P.O. BOX 1022, MINNEAPOLIS, MN, 55440-1022, US

(21) Appl. No.: 11/827,366

(22) Filed: Jul. 11, 2007

Related U.S. Application Data
(60) Provisional application No. 60/920,045, filed on Mar. 26, 2007.

(51) Int. Cl. H01M 10/36; H01M 4/58; H04R 25/00

(52) U.S. Cl. 429/94; 429/162; 429/231.95; 429/221; 381/323

(57) ABSTRACT

Secondary batteries are provided in which the cathode includes LiFePO₄ as an active material. In some implementations, the batteries include carbon anodes. Hearing aids containing such batteries, and cathodes for such batteries are also provided.

### RELATED APPLICATIONS

This application claims priority under 35 USC §119(e) from U.S. Provisional Patent Application Ser. No. 60/920,045, filed Mar. 26, 2007, the entire contents of which are herein incorporated by reference.

### TECHNICAL FIELD

This invention relates to lithium ion secondary batteries and to cathodes for such batteries.

### BACKGROUND

Batteries are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

Rechargeable batteries, also known as secondary batteries, contain active materials that are regenerated by charging. When the energy produced by these batteries drops below optimum efficiency, they may be recharged in any one of many manners, depending upon their construction. Rechargeable batteries are broken down into two main classifications based upon the chemical composition of the battery. Both of these classifications, alkaline secondary and lithium secondary, contain a wide assortment of battery styles.

In contrast to secondary cells, primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995). Secondary electrochemical cells can be recharged many times, e.g., more than fifty times, more than a hundred times, or more. In some cases, secondary cells can include relatively robust separators, such as those having many layers and/or that are relatively thick. Secondary cells can also be designed to accommodate changes, such as swelling, that can occur in the cells. Secondary cells are described, e.g., in Falk & Salkind, “Alkaline Storage Batteries”, John Wiley & Sons, Inc. 1969; U.S. Pat. No. 345,124; and French Patent No. 164,681, all hereby incorporated by reference.

Standard hearing aids use button cell primary (non-rechargeable) batteries based on zinc air chemistry. Zinc air chemistry has been widely adopted due to the high energy density in a small volume. Unfortunately, zinc air has limitations which tend to impede user satisfaction. The cells must be changed between once and twice a month due to both performance expiration and shelf life concerns. Zinc air cells are open to the air, and as such are plagued with electrolyte dry-out and carbonation build up on the cathode membrane, blocking air transport into the anode. Button cells tend to be difficult for the elderly population to change on a frequent basis, since they are small, making them difficult to see and handle.

### SUMMARY

The inventors have developed button cell type Li-ion secondary batteries in which the cathode contains LiFePO₄. Thus, in one aspect, the invention features a secondary battery comprising a button-shaped housing that houses an anode, a cathode including LiFePO₄, and a separator between the anode and the cathode. These batteries have desirable properties for use in hearing aids and other applications.

In some implementations, the Li-ion secondary batteries described herein are used in hearing aids, enabling the production of lower cost hearing aids. In some cases, the batteries described herein are fast-charge capable rechargeable cells that can provide more than 100 cycles, typically many hundreds or thousands of cycles, before they need to be replaced. Some preferred batteries have a capacity of greater than about 5 mAh, permitting more than 12 h/day service in a constant power drain.

The LiFePO₄ based rechargeable cells have sufficient capacity to provide at least a day of service time per charge and provide 1-3 years of daily use. The cells also have a charge capability of 15 minutes or less, preferably 5 minutes or less. In addition, preferred cells made using LiFePO₄ cathodes generally exhibit good safety, fast charging (e.g., 5 minutes or less), good power density, consistent performance, and environmental acceptability. The fast charge capability of 5 minutes or less minimizes user inconvenience (e.g., in hearing aid applications the hearing aid cannot be used during charging). The ability to charge the cell within the device eliminates the need for regular removal and insertion. Preferred batteries also provide excellent cycle life (>1000) and shelf life (3 years).

In some implementations, the cathode and anode are in the form of a folded electrode assembly, or, alternatively, a ribbon wound electrode. The button-shaped housing may have a volume of less than about 0.5 cm³, e.g., a volume of 0.25 cm³ or less. The button-shaped housing has a diameter to height ratio of greater than 1.

To allow the cathode and anode to fit within the button-shaped housing, the cathode and anode, prior to folding (for a folded electrode assembly) are preferably very thin. In some implementations, the cathode has a total thickness of less than 100 microns prior to folding and the anode has a total thickness of less than 75 microns prior to folding.

In another aspect, the invention features a hearing aid comprising (a) hearing aid components; and (b) a secondary battery, in electrical communication with the hearing aid components, in the form of a button cell comprising an anode, a cathode including LiFePO₄, and a separator between the anode and the cathode.

In yet a further aspect, the invention features a cathode for a secondary battery, the cathode comprising a substrate comprising two or more connected arcuate portions, such that when the substrate is folded the cathode will have a generally circular shape, wherein the substrate is coated on both sides with an active material comprising lithium. In some implementations, the active material comprises LiFePO₄. The invention also features folded electrode assemblies, comprising an anode, cathode and separator that are stacked and folded to form a generally circular folded electrode assembly, and button cells and hearing aids that include such electrode assemblies.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic view of a laminate used in a folded electrode assembly, prior to folding of the laminate.

### DETAILED DESCRIPTION

The batteries include a cathode including LiFePO₄ as its active material, a carbon anode, a separator and an electrolyte. Some preferred batteries are in the form of a button cell. The batteries are secondary batteries, i.e., they are rechargeable.

The cathode may also include a binder. The thickness of the cathode will depend upon the cell design and required performance characteristics.

The anode is generally a carbon anode. Other suitable anode materials may include alloy-based anodes (e.g., Li metal alloyed with Al, Si or Sn), and various metal oxides.

The battery will also include a separator and an electrolyte, as is well known in the battery art. In the cells described herein, the electrolyte is generally not consumed during charge and discharge. Accordingly, the amount of electrolyte is determined by the porous volume available in the electrode.

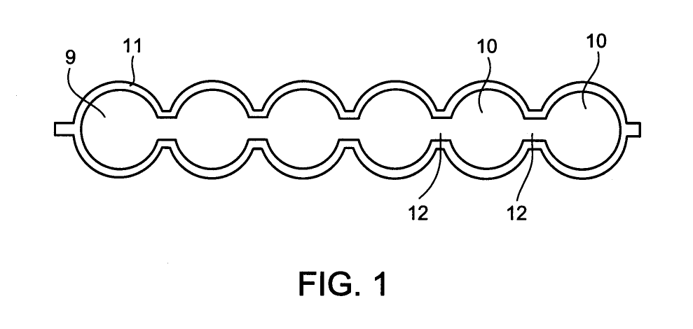

The battery uses a folded electrode design with interspaced cathode and anodes to increase the surface area, as shown in FIG. 1. In this case, the cathode 9 is laminated to the anode 11, with a separator (not shown) sprayed on or laminated in between the anode and cathode. As shown in FIG. 1, the electrodes are cut so that when the laminate is folded up the resulting folded electrode assembly has the desired shape for including in the particular type of cell, in the case of FIG. 1a button cell. Thus, as shown in FIG. 1, each electrode may include a plurality of arcuate shaped portions 10 that are connected by webs 12. Accordingly, when the arcuate shaped portions are folded upon each other the resulting folded electrode is generally circular and will fit into a button-shaped housing.

Each electrode (cathode and anode) can be fabricated by providing a substrate and coating the substrate on both sides with the appropriate material, for example carbon for the anode and a mixture of binder, conductive carbon and active material for the cathode. Preferably, for the cathode the coating on each side is from about 30 to 45 microns thick, so that the total cathode thickness, prior to folding, is about 70 to 90 microns. For the anode, it is preferred that the coating on each side be about 15 to 20 microns thick, so that the total anode thickness, prior to folding, is about 45 to 55 microns. The substrate for the cathode may be, for example, aluminum foil, and may have a thickness of from about 8 to about 35 microns. The substrate for the anode may be, for example, aluminum foil, and may have a thickness of from about 4 to about 35 microns.

The electrodes (the cathode and anode) may be individually punched into the required shape and laminated or assembled together before folding them to stack in a cylindrical volume. The top-most and bottom-most pieces of the stacked electrode assembly have opposite polarity and have mass free zones on their outer surfaces for electrical connections and proper cell balance. The mass free zones may be formed using any desired technique, for example by intermittent coating of the substrate, by masking, or by removal of portions of the coating from the locations desired for the mass free zones. The separator may be sprayed onto either one or both of the electrodes for ease of assembly, or may be a separate component that is laminated between the cathode and anode.

A similar approach could be extended to include conventional chemistries with high surface area electrodes. A LiCoO₂/C chemistry could give twice the capacity in the same volume, but the charge rate would be limited and electronics would be required for charge control.

Alternatively, ribbon type wound cells may be used in place of a stacked folded electrode design. In some cases it may be difficult to utilize this design in cells with less than 3 mm height due to tolerances. However, one advantage of a ribbon cell is that a high speed winding may be used with no special shape required for the electrode assembly. Ribbon cells differ from other wound cells in that their aspect ratio is low, typically less than about 2.3, and in some implementations less than 1.0, e.g., 0.4 to 0.8. The aspect ratio is defined as the ratio of the height of the cell to the diameter of the wound cell. Ribbon cells have a low aspect ratio due to their very small height. Ribbon cells provide good heat dissipation, since a large surface area of the electrode can be in close proximity to the can surface.

### EXAMPLES

The LiFePO₄ chemistry was evaluated for use in three button cell envelopes (#312, #13 and #675 from the Duracell Zn-air product lines). The cathode capacity, charge rate and cycle life of the LiFePO₄/C based chemistry were first measured in AA and AAA type cylindrical batteries, with results as shown below in Table 1.

TABLE 1
Cathode Performance of LiFePO4/C-based chemistry

| | Cathode | Demonstrated | | Demonstrated |
|---|---|---|---|---|
| | thick- | Cathode | Demonstrated | Cycle life |
| Cell Type & | ness | Capacity | Charge rate | in AA/AAA |
| design | (cm) | mAh/cm2 | (5 min) | format |
| AA wound | 0.0180 | 1.35 | 5 min to | >100 |
| | | | >90% charge | |
| AAA wound | 0.0090 | 0.59 | 10 sec to | >2000 |
| | | | 10% charge | |

Based on this data, the performance of the chemistry in button cells of various sizes was projected, as shown below in Table 2.

TABLE 2
Button cell dimensions and projected performance for LiFePO₄/C chemistry

| | | Button cell | | Button cell | | | Estimated | |
|---|---|---|---|---|---|---|---|---|
| | | External | | Internal | | | Energy | |
| Button cell | | Dimensions (cm) | | Dimensions (cm) | | Estimated cell | density | Estimated |
| Chemistry | Type | Diameter | Height | Diameter | Height | capacity (mAh) | (Wh) | Charge time |
| LiFePO₄/ | #312 | 0.75 | 0.32 | 0.70 | 0.22 | 5.5 | 0.018 | ≦5 minutes |
| C based | #13 | 0.75 | 0.50 | 0.70 | 0.40 | 10.9 | 0.036 | |
| Li-Ion | #675 | 1.12 | 0.50 | 1.07 | 0.40 | 27.6 | 0.090 | |

### Service Hour Estimation in a Hearing Aid Device:

Service hours for LiFePO₄/C rechargeable cells were estimated based on an assumption of constant power drain down to 2.5 V. The estimated service hours and charge times for various cell types are shown in Table 3 below.

TABLE 3
Service hours and charge times

| | Service hour | | |
|---|---|---|---|
| Cell | demonstrated/ | Charge | |
| Type | estimated | time | Advantage |
| 312 | 16 h | ≦5 minute | Could be re-used |
| 13 | 31.5 h | | with a 15 sec-5 min |
| 675 | 32 h | | charge cycle |

From the estimations in Table 3 it is clear that the rechargeable cells in all three formats would meet the requirement of 12 h per day discharge time on a constant power basis. Moreover, these rechargeable could be used hundreds to thousands of times and the charge time is very short between cycles.

A number of embodiments of the invention have been described. Nevertheless, it will be understood that various modifications may be made without departing from the spirit and scope of the invention.

For example, while the cells disclosed herein have been described above in the context of hearing aid applications, these cells can be used in many other applications, for example, but not limited to: low energy devices for monitoring temperature, pressure and other parameters, security devices, locks, transmitters, remote controls, and LED-based mechanical crank flashlights.

The cells described herein may include a LiFePO₄ cathode and a lithium titanate anode, and may be in the form of low voltage button cells for compatibility with the voltages used by most current hearing aids.

Accordingly, other embodiments are within the scope of the following claims.

What is claimed is:

1. A secondary lithium battery comprising:
a button-shaped housing that houses:
an anode;
a cathode including LiFePO₄; and
a separator between the anode and the cathode.

2. The battery of claim 1 wherein the battery is a hearing aid battery.

3. The battery of claim 1 wherein the anode comprises carbon.

4. The battery of claim 1 wherein the battery has a capacity of greater than about 5 mAh.

5. The battery of claim 1 wherein the battery has a charge capability of five minutes or less.

6. The battery of claim 1 wherein the cathode and anode are in the form of a folded electrode assembly.

7. The battery of claim 1 wherein the cathode and anode are in the form of a ribbon wound electrode.

8. The battery of claim 1 wherein the button-shaped housing has a volume of less than about 0.5 cm³.

9. The battery of claim 1 wherein the button-shaped housing has a volume of 0.25 cm³ or less.

10. The battery of claim 1 wherein the button-shaped housing has a diameter to height ratio of greater than 1.

11. The battery of claim 6 wherein the cathode has a total thickness of less than 100 microns prior to folding.

12. The battery of claim 6 wherein the anode has a total thickness of less than 75 microns prior to folding.

13. A hearing aid comprising
hearing aid components; and
a secondary battery, in electrical communication with the hearing aid components, in the form of a button cell comprising an anode, a cathode including LiFePO₄, and a separator between the anode and the cathode.

14. The hearing aid of claim 13 wherein the anode comprises carbon.

15. The hearing aid of claim 13 wherein the battery has a capacity of greater than about 5 mAh.

16. The hearing aid of claim 13 wherein the battery has a charge capability of five minutes or less.

17. The hearing aid of claim 13 wherein the cathode and anode are in the form of a folded electrode assembly.

18. The hearing aid of claim 13 wherein the cathode and anode are in the form of a ribbon wound electrode.

19. The hearing aid of claim 13 wherein the button-shaped housing has a volume of less than about 5 cm³.

20. The hearing aid of claim 13 wherein the button-shaped housing has a volume of 0.5 cm³ or less.

21. A cathode for a secondary battery, the cathode comprising
a substrate comprising two or more connected arcuate portions, such that when the substrate is folded the cathode will have a generally circular shape;
wherein the substrate is coated on both sides with an active material comprising lithium.

22. The cathode of claim 21 wherein the active material comprises LiFePO₄.

23. The battery of claim 1 wherein the battery has a charge capability of 15 minutes or less.
